(19) United States
(12) Patent Application Publication
(10) Pub. No.: US 2018/0145370 A1
(43) Pub. Date: May 24, 2018

(54) SOLID POLYMER ELECTROLYTE AND ELECTROCHEMICAL DEVICES COMPRISING SAME

(71) Applicant: RHODIA OPERATIONS, Paris (FR)

(72) Inventors: Olivier BUISINE, Saint Genis-Laval (FR); Claude MERCIER, Jonquieres (FR)

(21) Appl. No.: 15/568,055

(22) PCT Filed: Apr. 20, 2016
(86) PCT No.: PCT/EP2016/058705

§ 371 Date: Oct. 20, 2017

(30) Foreign Application Priority Data
Apr. 21, 2015 (FR) 1553548

(51) Int. Cl. H01M 10/0565; H01G 11/56

(52) U.S. Cl. CPC H01M 10/0565; G02F 1/1525; H01G 11/56

(57) ABSTRACT

The invention relates to a solid polymer electrolyte comprising a eutectic mixture comprising a fluorinated salt and an organic compound forming a eutectic mixture with said fluorinated salt. This solid polymer electrolyte can be obtained by polymerization and/or crosslinking of a composition comprising a eutectic mixture comprising a fluorinated salt and an organic compound forming a eutectic mixture with said fluorinated salt and a polymerizable and/or crosslinkable compound. In addition, the invention also relates to a process for producing said solid polymer electrolyte and to the uses thereof as an electrolyte in an electrochemical device, in particular as an electrolyte in a battery or in an electronic display device, in particular an electrochromic device.

### TECHNICAL FIELD OF THE INVENTION

The present invention relates to the field of materials that are of use in electrochemical applications. More specifically, this invention relates to a novel polymer material that can be used as an electrolyte.

### PRIOR ART

In the very dynamic technical field of batteries, part of the research effort is concentrated on improving the properties of the materials constituting the electrolyte.

To improve the quality and safety of batteries, patent document US 2007/0099090 proposes using a eutectic mixture as an electrolyte in electrochemical devices. According to this document, by virtue of its chemical and thermal stability, this eutectic mixture could make it possible to solve the problems associated with the volatility and inflammability of electrolytes. However, the electrolyte material proposed in this document does not have sufficient mechanical properties to be used alone in a battery: a separator material must additionally be used. Similar disclosures may be found in the patent applications US 2014/342239, EP 2 405 518 and WO 2006/033545.

Besides, the patent application US 2011/0051218 discloses an electrolyte for electrochromic devices manufacture by mixing a solvent, an ionisable substance and a solvated polymer. Contrary to the present invention, the object of US 2011/0051218 is not to obtain a solid material having good mechanical properties, but a liquid-like composition having suitable rheological properties for electrochromic devices having flexible substrates and/or manufactured by lamination.

It is in this context that the inventors have sought a novel material that can be used as an electrolyte in electrochemical devices. Advantageously, this material has good properties both in terms of ionic conductivity and in terms of mechanical properties.

### BRIEF DESCRIPTION OF THE INVENTION

A subject of the invention is a solid polymer electrolyte comprising a eutectic mixture comprising a fluorinated salt and an organic compound forming a eutectic mixture with said fluorinated salt. The expression “solid” means that the material has a Young's modulus of at least 1 MPa. This solid polymer electrolyte can be obtained by polymerization and/or crosslinking of a composition comprising a eutectic mixture comprising a fluorinated salt and an organic compound forming a eutectic mixture with said fluorinated salt and a polymerizable and/or crosslinkable compound.

In addition, a subject of the invention is also a process for producing said solid polymer electrolyte, comprising the steps in which a precursor composition comprising a eutectic mixture comprising a fluorinated salt and an organic compound forming a eutectic mixture with said fluorinated salt and a polymerizable and/or crosslinkable compound is obtained; then said precursor composition is subjected to a polymerization and/or crosslinking treatment. The precursor composition comprising a eutectic mixture comprising a fluorinated salt and an organic compound forming a eutectic mixture with said fluorinated salt and a polymerizable and/or crosslinkable compound is also a subject of the present invention.

Finally, the invention relates to the uses of said solid polymer electrolyte as an electrolyte in an electrochemical device, in particular as an electrolyte in a battery or in an electronic display device, in particular an electrochromic device.

### DESCRIPTION OF THE INVENTION

In the disclosure which follows, the expression “between . . . and . . . ” should be understood as including the mentioned limits.

The subject of the present invention is a solid polymer material that can be used as an electrolyte.

In the disclosure which follows, the expression “solid” denotes in particular a material having a Young's modulus of at least 1 MPa, preferably of at least 1.5 MPa, and more preferably of at least 2 MPa. The Young's modulus of the material can be calculated from the stress/strain curve of the material obtained by dynamic mechanical analysis.

Conventionally, a eutectic mixture denotes a mixture of at least two compounds having a melting point lower than that of each of the compounds taken individually. In the present invention, the eutectic mixture can advantageously have a melting point below 100° C., more preferably below 80° C., more preferably below 60° C., and even more preferably below 40° C. According to one embodiment, said eutectic mixture is liquid at operating temperature, this operating temperature depending on the electrochemical device in which the electrolyte is used. Preferably, the operating temperature is between 10° C. and 100° C., more preferably between 20° C. and 80° C., and more preferably between 25° C. and 60° C.

Said eutectic mixture is obtained by mixing a fluorinated salt and an organic compound forming a eutectic mixture with said fluorinated salt.

The fluorinated salt may consist of a fluorinated monoanion or polyanion and of one or more cations. The cation(s) may be selected, independently of one another, from metal cations and organic cations. As metal cation, mention may preferably be made of alkali metal cations, alkaline-earth metal cations and cations of d-block elements. As organic cation, mention may be made of imidazolium cations, pyrrolidinium cations, pyridinium cations, guanidinium cations, ammonium cations and phosphonium cations. According to one preferred embodiment, the fluorinated salt comprises at least one alkali metal cation, preferentially at least one lithium or sodium cation, and more preferentially at least one lithium cation. Said fluorinated salt may be a fluorinated lithium salt or a fluorinated sodium salt, preferably a fluorinated lithium salt.

Among the fluorinated anions that can be used in the present invention, fluorinated sulfonimide anions may be advantageous. The fluorinated anion may in particular be selected from the anions having the following general formula:

(Ea-SO₂)N⁻R

in which:
Ea represents a fluorine atom or a group having preferably from 1 to 10 carbon atoms, selected from fluoroalkyls, perfluoroalkyls and fluoroalkenyls,
R represents a substituent.

According to a first embodiment, R represents a hydrogen atom.

According to a second embodiment, R represents a linear or branched, cyclic or non-cyclic hydrocarbon-based group, preferably having from 1 to 10 carbon atoms, which can optionally bear one or more unsaturations, and which is optionally substituted one or more times with a halogen atom or with a nitrile function.

According to a third embodiment, R represents a sulfonyl group. In particular, R may represent the group —SO₂-Ea, Ea being as defined above. In this case, the fluorinated anion may be symmetrical, i.e. such that the two Ea groups of the anion are identical, or non-symmetrical, i.e. such that the two Ea groups of the anion are different. Moreover, R may represent the group —SO₂—R′, R′ representing a linear or branched, cyclic or non-cyclic hydrocarbon-based group, preferably having from 1 to 10 carbon atoms, which is optionally substituted one or more times with a halogen atom and which can optionally bear one or more unsaturations. In particular, R′ may comprise a vinyl group, an allyl group or an aromatic group which is itself optionally substituted with one or more halogen atoms and/or with one or more haloalkyl groups. Furthermore, R may represent the group —SO₂—N⁻R′, R′ being as defined above or else R′ represents a sulfonate function SO₃⁻.

According to a fourth embodiment, R represents a carbonyl group. R may in particular be represented by the formula —CO—R′, R′ being defined as above.

The fluorinated anion that can be used in the present invention may advantageously be selected from the group consisting of:
CF₃SO₂N⁻SO₂CF₃,
CF₃SO₂N⁻SO₂F,
FSO₂N⁻SO₂F, and
CF₃SO₂N⁻SO₂N⁻SO₂CF₃.

The fluorinated anions that can be used in the present invention may also be selected from the group consisting of PF₆⁻, BF₆⁻, AsF₆⁻, fluoroalkyl borates, fluoroalkyl phosphates and fluoroalkyl sulfonates, in particular CF₃SO₃⁻.

Generally, the fluorinated salt according to the invention can be described by the overall formula below:

Aⁿ⁻M1¹⁺₍ₘ₎M2^{p+}_{((n-m*1)/p)}

in which:
A represents a fluorinated anion;
M1 and M2 represent cations;
n, 1 and p, independently selected between 1 and 5, represent respectively the charges of the fluorinated anion, of the cation M1 and of the cation M2;
m, selected between 1 and 2, represents the stoichiometry of the cation M1.

The fluorinated anion A and the cations M1 and M2 may be as preferentially described above.

The fluorinated salt that can be used in the present invention may advantageously be selected from the group consisting of lithium bis(trifluoromethanesulfonyl)imide of formula (CF₃SO₂)₂NLi (commonly denoted LiTFSI) and lithium bis(fluorosulfonyl)imide of formula (F—SO₂)₂NLi (commonly denoted LiFSI).

To form a eutectic, said fluorinated salt is mixed with an organic compound forming a eutectic mixture with said fluorinated salt. Such compounds capable of forming a eutectic with a fluorinated salt are known to those skilled in the art.

Preferably, said organic compound is selected from organic compounds comprising at least one amide function and/or at least one sulfone function. The organic compound may be selected from the group consisting of sulfones preferably having from 1 to 10 carbon atoms, alkylamides preferably having from 1 to 10 carbon atoms, alkenylamides preferably having from 2 to 10 carbon atoms and arylamides, said alkyl, alkenyl and aryl groups possibly being unsubstituted or substituted one or more times with other amide functions and/or one or more alkyl groups optionally substituted one or more times with halogen atoms. Said amide function may be primary, secondary or tertiary, preferably primary, and it may be unsubstituted, monosubstituted or disubstituted on the nitrogen atom. When it is mono-substituted or disubstituted on the nitrogen atom, the substituent groups may be selected from alkyl groups preferably having from 1 to 10 carbon atoms, alkenyl groups preferably having from 2 to 10 carbon atoms and aryl groups, said alkyl, alkenyl and aryl groups possibly being unsubstituted or substituted one or more times with halogen atoms, or alkyl groups optionally substituted with halogen atoms. The organic compound may have a linear structure or a cyclic structure. According to one particular embodiment, the organic compound has a cyclic structure and the amide function is part of said ring.

The organic compound capable of forming a eutectic with a fluorinated salt in the present invention may be selected from the group consisting of acetamide, N-methylacetamide, urea, N-methylurea, caprolactam, valerolactam, trifluoroacetamide, methyl carbamate, formamide, N-methylpyrrolidone, dimethyl sulfone and mixtures thereof.

The mole ratio between fluorinated salt and the organic compound in the eutectic mixture according to the invention depends on said eutectic formed. Generally, this ratio may be between 1:1 and 1:4. Nevertheless, in the present invention, the respective amounts of fluorinated salt and of organic compound may depart from this molar ratio. For example, the amount of fluorinated salt and/or of organic compound in the mixture may exceed the mole ratio by 20%.

In the present invention, the eutectic mixture also includes the mixture of several eutectics and the mixture of a eutectic with another compound which may in turn form a deeper eutectic.

The eutectic mixture may represent between 30% and 80% by weight of the total weight of the solid polymer electrolyte which is the subject of the present invention, more preferably between 35% and 70%, and even more preferably between 40% and 60%.

The eutectic mixture according to the invention may quite particularly be selected from the group consisting of the following eutectic mixtures:
LiTFSI/N-methylacetamide;
LiTFSI/dimethyl sulfone;
LiTFSI/urea.

The electrolyte according to the invention can be obtained by polymerization and/or crosslinking of a composition termed “precursor composition” which comprises, on the one hand, a eutectic mixture comprising a fluorinated salt and an organic compound forming a eutectic mixture with said fluorinated salt and, on the other hand, a polymerizable and/or crosslinkable compound. Said precursor composition is also a subject of the present invention.

Said polymerizable and/or crosslinkable compound may in particular be selected from monomers having one or more polymerizable and/or crosslinkable functions, preferably from the group consisting of:
ethylenically unsaturated monomers, in particular:
   aromatic ethylenically unsaturated monomers, such as styrene, α-methylstyrene, divinylbenzene, vinyltoluene, vinylnaphthalene, styrenesulfonic acids, and mixtures thereof;
   olefinic monomers, such as ethylene, isoprene, butadiene, and a mixture thereof;
   halogenated unsaturated monomers, such as vinyl chloride, chloroprene, vinylidene chloride, vinylidene fluoride, vinyl fluoride, and mixtures thereof;
   acrylic monomers, such as unsaturated acids typified by acrylic acid, methacrylic acid, crotonic acid, maleic acid, fumaric acid, and maleic anhydride; acrylates typified by methyl acrylate, ethyl acrylate, n-butyl acrylate, 2-ethylhexyl acrylate, hydroxyethyl acrylate, hydroxypropyl acrylate, dimethylaminomethyl acrylate, or any other acrylate derivative; methacrylates typified by methyl methacrylate, butyl methacrylate, lauryl methacrylate, dimethylaminoethyl methacrylate and stearyl methacrylate; acrylonitrile, acrolein; unsaturated resins, such as acrylic epoxy resins, polyethylene glycol diacrylate, polyethylene glycol dimethacrylate and trimethylolpropane triacrylate; and mixtures thereof;
   unsaturated amides, such as acrylamide, methacrylamide, N,N-dimethylacrylamide, methylenebisacrylamide and N-vinylpyrrolidone;
   unsaturated ethers, such as vinyl methyl ether;
   epoxide monomers, such as glycidyl ether monomers;
   isocyanate monomers, such as toluene diisocyanate, hexamethylene diisocyanate, isophorone diisocyanate, trimers thereof and oligomers thereof. These derivatives can be used in the presence of co-monomers of alkyl diol type, for instance ethanediol, dihydroxy telechelic oligo- and polyethylene glycols, alkyl triols, for instance glycerol, triethanolamine, alkyl tetraols, diamines, for instance ethylenediamine, Jeffamine® EDR polyetheramines, polyamines, for instance diethylenetriamine, triethylenetetramine, tetraethylenepentamine;
   silicate and alkoxysilane monomers, such as tetraethoxysilane and tetramethoxysilane.
      Said polymerizable and/or crosslinkable compound may also be selected from crosslinkable silicone prepolymers, such as silicones bearing epoxy or (meth)acrylate functions.

Preferably, the polymerizable and/or crosslinkable compound may be selected from the group consisting of ethylenically unsaturated monomers, epoxide monomers, silicate and alkoxysilane monomers, and mixtures thereof, more preferably from the group consisting of acrylic monomers, alkoxysilane monomers and mixtures of acrylic monomers and alkoxysilane monomers.

A single polymerizable and/or crosslinkable compound can be used in the present invention. However, it is not excluded to use a mixture of several different polymerizable and/or crosslinkable compounds.

The polymerizable and/or crosslinkable compound may hold one or several polymerizable and/or crosslinkable functional groups. The number of polymerizable and/or crosslinkable functional groups may have an influence on the rigidity of the final material. For example, di-functional compounds or tri-functional compounds may be selected in order to obtain a more rigid material.

The polymerizable and/or crosslinkable compound may represent between 1% and 70% by weight of the total weight of the solid polymer electrolyte which is the subject of the present invention, more preferably between 5% and 60%, and even more preferably between 20% and 50%.

In the solid polymer electrolyte which is the subject of the present invention, the weight ratio of the polymerizable and/or crosslinkable compound relative to the eutectic mixture may be between 0.01 and 2.5, preferably between 0.05 and 1.5, and more preferably between 0.25 and 1.

The polymerization and/or crosslinking mechanism depends on the compound chosen. It may, for example, be a polymerization and/or a crosslinking activated by heat treatment, by photochemical treatment, in particular by UV treatment, or by chemical treatment.

The precursor composition according to the invention may also comprise at least one appropriate polymerization initiator compound. Among the well-known thermal radical polymerization initiators, mention may, for example, be made of peroxide or hydroperoxide organic compounds such as benzoyl peroxide, acetyl peroxide, dilauryl peroxide, di-tert-butyl peroxide, cumyl hydroperoxide or hydrogen peroxide, compounds of azo type such as 2,2-azobis(2-cyanobutane), 2,2-azobis(methylbutyronitrile), AIBN (azobis(isobutyronitrile)) or AMVN (azobisdimethylvaleronitrile), and organometallic compounds such as alkylated silver compounds. Among the well-known photoinitiators, mention may be made of chloroacetophenone, diethoxyacetophenone (DEAP), 1-phenyl-2-hydroxy-2-methylpropanone (HMPP), α-aminoacetophenone, benzoin ether, benzyl dimethyl ketal, benzophenone, thioxanthone and 2-ethylanthraquinone (2-ETAQ), anthraquinone, anisoin and 1-hydroxycyclohexyl phenyl ketone. Among the cationic polymerization initiators, mention may be made of sulfonium and iodonium derivatives such as the photoinitiators IRGACURE® 184, IRGACURE® 500, DAROCURE® 1173, IRGACURE® 1700, DAROCURE® 4265, IRGACURE® 907, IRGACURE® 369, IRGACURE® 261, IRGACURE® 784 DO, IRGACURE® 2959 and IRGACURE® 651 sold by the company BASF.

Typically, the polymerization or crosslinking initiator compound(s) may represent between 0.001% and 1% by weight of the total weight of the solid polymer electrolyte which is the subject of the present invention, more preferably between 0.01% and 0.5%, and even more preferably between 0.05% and 0.2%.

Moreover, the polymer electrolyte which is the subject of the present invention may comprise one or more additives. The additives used may be of organic, mineral or hybrid nature.

The solid polymer electrolyte which is the subject of the present invention may comprise a solvent or a mixture of solvents, preferably organic solvents. The solvent may be selected from polar organic solvents, such as alkyl carbonates, for example diethyl carbonate, ethylene carbonate and propylene carbonate, sulfolane, dimethylformamide, ethers, for instance diisopropyl ether or dimethoxyethane, glymes, such as diglyme, triglyme or tetraglyme, polyether compounds with chain terminations selected from C₂₋₆ alky groups and halogenated or un-halogenated ester groups, for example CF₃COO—, HCF₂COO—, HCF₂CF₂COO—, CF₃CF₂CF₂COO—, and ClCF₂COO—, and longer-chain ethanediol oligomers, aromatic ethers, for instance anisole and veratrole, oxygen-bearing cyclic ethers, for example dioxolane, dioxane, tetrahydrofuran and tetrahydropyran, ionic liquids, and mixtures thereof. Preferably, the solid polymer electrolyte which is the subject of the present invention comprises a solvent selected from acetonitrile, glycol ethers, for instance glyme, diglyme, triglyme and tetraglyme, ethylene carbonate, propylene carbonate, and a mixture thereof. Typically, the solvent may represent between 0% and 50% by weight of the total weight of the solid polymer electrolyte which is the subject of the present invention, more preferably between 0% and 40%, and even more preferably between 5% and 30%.

The solid polymer electrolyte which is the subject of the present invention may further comprise a solide plasticizer. Succinonitrile (SCN) may be used as solid plasticizer, as disclosed in the scientific publication of M. Echeverri et al (“Ionic conductivity in Relation to Ternary Phase Diagram of Poly(ethylene oxide), Succinonitrile and Lithium Bis(trifluoromethane)sulfonimide Blends”, Macromolecules, 2012, 45, 6068-6077). Alternatively, solid plasticizer may be selected from the fluoro-amide compounds. In this text, the expression “fluoro-amide compound» refers to a compound having at least one amide functional group and at least one fluorine atom. It can be cited, for example, N-methyl-trifluoroacetamide, N-methyl-trifluorosulfonamide, N,N′-bis(trifluoroacetamide) ethane-1,2-diamine and N,N′-bis(trifluorosulfonamide) ethane-1,2-diamine.

The polymer electrolyte which is the subject of the present invention may comprise one or more texturing agents. In the disclosure which follows, the expression “texturing agent” denotes an agent capable of modifying the mechanical properties of a material, and includes, for example, fluidifying agents, gelling agents and curing agents. Said texturing agent may be a polymer. It may be selected from the group consisting of polyethylene, polypropylene, polystyrene, fluoropolymers, for instance PVDF (polyvinylidene fluoride), PTFE (polytetrafluoroethylene), perfluoropolyethers (PFPEs) and copolymers thereof, for instance the PVDF-HFP (polyvinylidene fluoride-hexafluoropropylene) copolymer, poly(meth)acrylates, for instance PMMA (polymethyl methacrylate), a polysaccharide or a derivative thereof, for instance cellulose, cellulose acetate, lignin and guar gum, a gelatin and a one-, two- or three-dimensional polysiloxane. Said texturing agent can be inert or else it can contain residues and/or chemical functions that can interact with one or more compounds of the medium. The texturing agent may be in liquid or solid form. When it is a solid additive, the size of this solid additive can range from a few nanometres to several hundred microns. Typically, the texturing agent(s) may represent between 0.1% and 60% by weight of the total weight of the polymer electrolyte which is the subject of the present invention, more preferably between 10% and 60%, and even more preferably between 30% and 50%.

Furthermore, the polymer electrolyte which is the subject of the present invention may comprise one or more mineral fillers. Said mineral filler may be selected from the group consisting of hydrophilic silica, hydrophobic silica, in particular fumed silicas, alumina, silicates, for example mica, metal oxides, hydroxides, phosphates, sulfides, nitrates and carbonates, such as, for example, a cerium oxide, a rare-earth metal oxide, zinc oxide, titanium oxide, tin oxide, indium tin oxide, and mixtures thereof. The size of the mineral filler can range from a few nanometres to several hundred microns. Preferably, the mineral fillers contained in the polymer electrolyte according to the invention are nanofillers. This advantageously makes it possible to obtain a material which has better mechanical properties and which is optionally transparent. Typically, the mineral filler(s) may represent between 0.1% and 60% by weight of the total weight of the polymer electrolyte which is the subject of the present invention. When it is a question of nanofillers, these nanofillers may more preferentially represent between 0.1% and 10% by weight of the total weight of the polymer electrolyte. When it is a question of fillers of larger sizes, they may more preferentially represent between 10% and 60% by weight of the total weight of the polymer electrolyte.

Preferably, the polymer electrolyte which is the subject of the present invention may comprise one or more texturing agents in combination with one or more mineral fillers.

Other types of additives may be included in the polymer electrolyte which is the subject of the present invention. However, it is preferable for the total amount of additives present in the electrolyte to represent at most 50% by weight, relative to the total weight of the polymer electrolyte which is the subject of the present invention, preferably between 0% and 40%, more preferably between 0% and 10%, and even more preferably between 0% and 3%.

The additives may in particular be selected from the additives conventionally used in battery electrolytes, for example SEI-controlling additives, monofluoroethylene carbonate or difluoroethylene carbonate. Pigments may also be used as additives, in particular when the electrolyte according to the invention is intended to be used in an electrochromic device.

The process for producing a solid polymer electrolyte is also a subject of the present invention. This process comprises the steps of:
obtaining a precursor composition comprising a eutectic mixture comprising a fluorinated salt and an organic compound forming a eutectic mixture with said fluorinated salt and a polymerizable and/or crosslinkable compound; then
subjecting said precursor composition to a polymerization and/or crosslinking treatment.

In order to obtain said precursor composition, the various compounds can be mixed in an appropriate device. According to one preferred embodiment, at least one fluorinated salt and at least one organic compound forming a eutectic mixture with said fluorinated salt are first mixed in the desired proportions, so as to obtain a eutectic mixture. Said eutectic mixture is then mixed with at least one polymerizable and/or crosslinkable compound. If necessary, the additive(s) can be added at any step of the preparation of said precursor composition.

The solid polymer electrolyte according to the invention is then obtained by subjecting said precursor composition to a polymerization treatment. This treatment may be chosen by those skilled in the art according to the polymerizable and/or crosslinkable compound chosen. The polymerization and/or crosslinking treatment may be selected from the group consisting of a heat treatment, a photochemical treatment, in particular a UV treatment, a chemical treatment, and a combination of these treatments.

According to one preferred embodiment, the precursor composition comprises a monomer typified by polyethylene glycol diacrylate and/or trimethylolpropane triacrylate and the polymerization and/or crosslinking treatment consists of UV irradiation of the mixture. The irradiation can typically be carried out using a medium-pressure mercury lamp. The operation can be carried out under an internal and anhydrous atmosphere. The irradiation can typically be maintained for a period of between a few minutes and a few hours, for example between 1 minute and 10 minutes.

Before carrying out the treatment step, the precursor composition can be shaped. This shaping step can, for example, consist of a step of depositing on a support, so as to obtain a film. This support may be an inert substrate, with a view to obtaining an electrolyte in the form of a self-supported film. Alternatively, said support may be a preformulated electrode, with a view to obtaining an electrolyte in the form of a coating. Alternatively, the precursor composition can be deposited or injected into a mold or into a device. Preferably, the precursor composition is not laminated between two substrates. The viscosity of the precursor composition is not specifically limited. However, it may be above 1000 Pa·s, even above 1500 Pa·s (at 22° C. and a shear rate of 4 s⁻¹).

The preparation process according to the invention may also comprise one or more post-treatment steps. In particular, said process may comprise an aging step, also termed terminating or maturing step. This aging treatment may consist of a heat treatment or else of a pause time under controlled temperature and humidity conditions

Generally, the process for producing a polymer electrolyte according to the invention can be carried out in a room with controlled hygrometry. All the raw materials preferably have a controlled water content.

This production process can be continuous or batchwise. In batchwise mode, the electrolyte according to the invention can be produced in batches according to conventional methods. However, for large-scale production, a continuous production process can be envisioned. Each step of the process (in particular the steps of preparing the precursor composition, of shaping and of polymerization and/or condensation and crosslinking treatment) can be independently carried out continuously or non-continuously. For example, the preparation of the precursor composition can be carried out industrially by means of extruders or static mixers, then the film-forming can be obtained by rolling or dipping, and the polymerization and/or crosslinking treatment can finally be obtained by passing under industrial lamps or through an oven.

The product obtained by this production process is a polymer material which can advantageously be used as an electrolyte. Indeed, this material has an ionic conductivity advantageously greater than 10⁻⁵, preferentially greater than 10⁻⁴ and even more preferentially greater than 10⁻³ siemens/cm at 20° C. Preferably, the ionic conductivity is between 5.10⁻⁴ and 10⁻² siemens/cm at 20° C. Furthermore, this material can advantageously have an ionic conductivity greater than 10⁻⁶, preferentially greater than 10⁻⁵, siemens/cm at 0° C. In addition, this material can advantageously have an ionic conductivity greater than 5.10⁻⁴ siemens/cm at 40° C. The ionic conductivity can be measured by the complex impedance spectrometry technique which makes it possible to measure the resistance and the capacity of a solid material. For this, the sample is held between two metal electrodes which are connected to an impedance meter which makes it possible to carry out the measurement. These measurements are carried out at a controlled temperature. Furthermore, the material obtained according to the invention is advantageously electrochemically stable.

In addition, the material obtained is advantageous since, contrary to the prior art electrolytes, it is solid. This electrolyte can therefore advantageously be a self-supported or free standing film, i.e. that it can exist and be handled without a support, unlike for example a coating or a gel injected into a porous support. It can in particular be used without a separator. Nevertheless, it is not excluded in the present invention to use this material with a separator, for example with a woven or nonwoven and/or microporous separator.

According to one preferred embodiment, the polymer electrolyte according to the invention can be in the form of a film, the thickness of which can be between 1 μm (micrometer) and 1 mm, preferably between 1 μm and 150 μm, more preferably between 1 μm and 100 μm, and even more preferably between 1 μm and 40 μm. Advantageously, the thickness of the film may be uniform over its entire surface area. In the present disclosure, the expression “uniform” denotes a variation in the thickness of the film of less than or equal to 50%, preferably less than or equal to 25%. The surface area of this film may be greater than 25 cm², or even greater than 100 cm², up to several hundred square metres in the context of continuous production.

According to one particularly advantageous embodiment, the solid polymer electrolyte according to the invention is transparent. In this case, the electrolyte preferably contains no additive that can harm the transparency of the product.

The invention advantageously provides a solid electrolyte material which has both a high conductivity and good mechanical properties. In addition, this material is easy to produce and inexpensive.

The solid polymer electrolyte according to the invention can advantageously be used as an electrolyte in an electrochemical device, and more particularly in electronic display devices or in energy storing and releasing devices. The solid polymer electrolyte according to the invention can, for example, be used as an electrolyte in one of the following electrochemical devices:
electrochromic devices: car windows or windows in houses, visors, eyeglasses, etc.,
electrochromic flat screens: televisions, tablets, smartphones, connected devices, etc.,
secondary lithium batteries, batteries of lithium-sulfur type, lithium-air batteries, sodium batteries, etc.,
supercapacitors, in particular double-layer supercapacitors using an electrolyte;
energy generators, such as solar panels of organic type (known under the abbreviation OPV).

A subject of the present invention is a battery comprising an anode, a cathode and a solid polymer electrolyte as defined above. Advantageously, such a battery does not contain a separator. Nevertheless, a battery containing a separator, for example with a woven or nonwoven and/or microporous separator, is not excluded in the present invention. Furthermore, the polymer electrolyte according to the invention may be part of the composition of the anode and/or of the cathode.

A subject of the present invention is also an electronic display device, in particular an electrochromic device, comprising at least one solid polymer electrolyte as defined above. This use is made possible by the fact that the solid polymer electrolyte according to the invention can advantageously be transparent.

The invention will now be described by means of the following examples given by way of nonlimiting illustration of the invention.

### EXAMPLES

### Example 1

Step a: A eutectic mixture was prepared by mixing lithium bis(trifluoromethanesulfonyl)imide (LiTFSI; 7.9 g) with N-methylacetamide (7.1 g) under a nitrogen atmosphere and at ambient temperature. The mixing is performed until a colorless liquid is obtained at ambient temperature.

Step b: An additional amount of LiTFSI (10.0 g) was dissolved in triethylene glycol diacrylate (17.4 g) at a temperature of 40° C. After returning to ambient temperature, 2.6 g of this solution were added to the eutectic mixture formed during step a. PVDF (15 g) and then the photoinitiator (IRGACURE® 184, sold by the company BASF, 0.3 g) were added to the whole of the formulation with stirring.

Step c: The preparation obtained in step b was spread in the form of a film using a BYK automatic film applicator. For this, 5 g of the formulation obtained in step b were placed on a sheet of aluminum 30 μm thick. A gage which makes it possible to adjust the applied liquid formulation height was adjusted to a height of 200 μm. A non-crosslinked film of constant thickness was thus obtained.

Step d: The crosslinking was carried out under UV irradiation produced by a LumenDynamics Omnicure® S1000 device equipped with a medium-pressure mercury lamp having a power of 100 W. The lamp was placed at a height of 50 cm above the film. The irradiation was maintained for 2 minutes at full power.

The material obtained has a thickness of between 80 μm and 125 μm.

The resistivity measurement was carried out with an Impedance/Gain-Phase Analyzer S1 1260 device sold by SOLARTRON. The measurement frequency ranges from 1 Hz to 1 MHz with a variation of 10 Hz per point. The measuring cell has a surface area of S=0.196 cm². The sample was placed between the two electrodes at a temperature of T=27° C. and subjected to the analysis protocol as defined above. This resistivity measurement made it possible to calculate a conductivity of 3.42×10⁻² S/cm.

The electrochemical stability measurement was carried out in a sealed measuring cell mounted under dry argon, having a surface area S=1.13 cm². The membrane is brought into contact with a 316 stainless steel electrode and a lithium electrode, said electrode acting as counterelectrode and as reference electrode. The open circuit potential measured is 2.73 V and the potential variation is carried out at a rate of 1 mV/s by a VMP3-type potentiostat sold by the company Biologic, between an upper limit of 4.5 V and a lower limit of 0 V, relative to the lithium reference. The current is measured with a sensitivity of 10 μA. No oxidation or reduction peak was detected in the range considered, thereby reflecting the absence of degradation of the membrane.

### Example2

The protocol of example 1 was reproduced, with the difference that silica (3 g, specific surface area 160 m²/g, mean particle size 300 μm) was mixed with 10 g of the solution previously obtained in step b.

A film on average 165 μm thick was obtained. An ionic conductivity of 10⁻⁴ S/cm at a temperature of 23° C. was obtained.

The measurement of the solidity of the film obtained was carried out by compression using superimposed films in order to obtain a test specimen with a thickness greater than 1 mm. The cylindrical test specimens were cut out using a hole punch with a diameter between 5 and 15 mm. The tests were carried out by dynamic mechanical analysis on a Rheometrics RSA 2 device which makes it possible to apply a sinusoidal strain and to measure the corresponding force. The modulus measured is the tangent to the stress/strain curve for a strain of 1% at a frequency of 1 Hz and a temperature of 23° C. The Young's modulus of this film thus determined leads to a value of 2 MPa.

1. A solid polymer electrolyte comprising a eutectic mixture comprising a fluorinated salt and an organic compound forming a eutectic mixture with said fluorinated salt.

2. The solid polymer electrolyte according to claim 1, wherein the fluorinated salt comprises at least one alkali metal cation.

3. The solid polymer electrolyte according to claim 2, wherein the fluorinated salt comprises at least one lithium or sodium cation.

4. The solid polymer electrolyte according to claim 3, wherein the fluorinated salt comprises at least one lithium cation.

5. The solid polymer electrolyte according to claim 1, wherein the fluorinated salt comprises at least one fluorinated anion selected from fluorinated sulfonimide anions.

6. The solid polymer electrolyte according claim 5, wherein the fluorinated salt comprises at least one fluorinated anion selected from the anions having the following general formula:
(Ea-SO₂)N⁻R
in which:
Ea represents a fluorine atom or a group, selected from fluoroalkyls, perfluoroalkyls and fluoroalkenyls,
R represents a substituent.

7. The solid polymer electrolyte according claim 6, wherein the fluorinated salt comprises at least one fluorinated anion selected from the group consisting of:
CF₃SO₂N⁻SO₂CF₃,
CF₃SO₂N⁻SO₂F,
FSO₂N⁻SO₂F, and
CF₃SO₂N⁻SO₂N⁻SO₂CF₃.

8. The solid polymer electrolyte according to claim 1, wherein the eutectic mixture is selected from the group consisting of the following eutectic mixtures:
LiTFSI/N-methylacetamide;
LiTFSI/dimethyl sulfone;
LiTFSI/urea.

9. The solid polymer electrolyte according to claim 1, wherein it is obtained by polymerization and/or crosslinking of a composition comprising said eutectic mixture comprising a fluorinated salt and an organic compound forming a eutectic mixture with said fluorinated salt and a polymerizable and/or crosslinkable compound.

10. The solid polymer electrolyte according to claim 9, wherein the polymerizable and/or crosslinkable compound is selected from the group consisting of ethylenically unsaturated monomers, epoxide monomers, silicate and alkoxysilane monomers, and mixtures thereof.

11. The solid polymer electrolyte according to claim 10, wherein the polymerizable and/or crosslinkable compound is selected from the group consisting of acrylic monomers, alkoxysilane monomers and mixtures of acrylic monomers and alkoxysilane monomers.

12. The solid polymer electrolyte according to claim 1, wherein the polymer electrolyte comprises one or more mineral fillers.

13. The solid polymer electrolyte according to claim 1, wherein the polymer electrolyte comprises one or more texturing agents.

14. The solid polymer electrolyte according to claim 1, wherein it has a Young's modulus of at least 1 MPa.

15. The solid polymer electrolyte according to claim 1, wherein it has an ionic conductivity advantageously greater than 10⁻⁵ siemens/cm at 20° C.

16. The solid polymer electrolyte according to claim 1, wherein it has an ionic conductivity greater than 10⁻⁶ siemens/cm at 0° C.

17. The solid polymer electrolyte according to claim 1, wherein it is self-supported.

18. The solid polymer electrolyte according to claim 1, wherein it is in the form of a film, the thickness of which is between 1 μm and 1 mm.

19. The solid polymer electrolyte according to claim 1, wherein it is transparent.

20. A process for producing a solid polymer electrolyte as claimed in claim 1, comprising the steps of obtaining a precursor composition comprising a eutectic mixture comprising a fluorinated salt and an organic compound forming a eutectic mixture with said fluorinated salt and a polymerizable and/or crosslinkable compound; then subjecting said precursor composition to a polymerization and/or crosslinking treatment.

21. A precursor composition for a solid polymer electrolyte material as claimed in claim 1, comprising a eutectic mixture comprising a fluorinated salt and an organic compound forming a eutectic mixture with said fluorinated salt and a polymerizable and/or crosslinkable compound.

22. (canceled)

23. A battery comprising an anode, a cathode and a solid polymer electrolyte as defined in claim 1.

24. An electronic display device comprising at least one solid polymer electrolyte as defined in claim 1.
